(19) United States
(12) Patent Application Publication
(10) Pub. No.: US 2020/0265756 A1
(43) Pub. Date: Aug. 20, 2020

(54) DIGITAL TOUCH SCREEN REAL ESTATE SIGN

(71) Applicants: Alex Agadzhanyan, Sunland, CA (US); Mesrop Agadzhanyan, Sunland, CA (US); David Agadzhanyan, Sunland, CA (US)

(72) Inventors: Alex Agadzhanyan, Sunland, CA (US); Mesrop Agadzhanyan, Sunland, CA (US); David Agadzhanyan, Sunland, CA (US)

(21) Appl. No.: 16/794,403

(22) Filed: Feb. 19, 2020

Related U.S. Application Data
(60) Provisional application No. 62/807,744, filed on Feb. 19, 2019.

(51) Int. Cl. G09F 7/02; G06F 3/041

(52) U.S. Cl. CPC G09F 7/02; G06F 3/0412

(57) ABSTRACT

A smart sign that allows users to interact with a digital real estate sign. The sign is preferably powered by solar energy, but may also be hardwired for electricity. The sign will include a battery that collects and stores the necessary amount of solar energy to operate. The sign has a flexible base with a pivot point that allows the sign to bend near the base and withstand being struck or moved in heavy wind. The sign also has a camera, which is preferably also powered by solar energy. The camera allows users to remotely view the property for sale near the sign. The sign also has a touch screen, allowing users to interact with the sign, and will be operable via Wi-Fi and Bluetooth. The sign also includes a programmable device that can collect data entered on the touch screen by the user.

### CROSS-REFERENCE TO RELATED APPLICATION

The present application is related to and claims priority from prior provisional application Ser. No. 62/807,744, filed Feb. 19, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of smart signs, and specifically to the field of outdoor real estate signs. More specifically, the invention is an electrical outdoors touch screen real estate sign that is W-Fi compatible and includes a camera.

### 2. Description of the Related Art

Currently, real estate signs are large wood or poster board signs that hang, often by a hook on either side of the top of the sign, from a post that is planted in the yard of a building that is for sale. In order to be seen at night, spotlights must be installed around the sign to light it up. The sign is limited in its display to whatever is printed or painted on it at the time of installation. Further information about the building is often provided via flyers placed in a box attached to the post.

Ideally, a smart real estate sign should provide an electrical sign that is visible at night, includes a touch screen so that more information is available to prospective purchasers, is Wi-Fi and/or Bluetooth compatible, and includes a camera, and, yet would operate reliably and be manufactured at a modest expense. Thus, a need exists for a reliable electrical touch screen real estate sign to avoid the above-mentioned problems.

### BRIEF SUMMARY OF THE INVENTION

In view of the foregoing disadvantages inherent in the known real estate sign art, the present invention provides a novel electrical touch screen real estate sign. The general purpose of the present invention, which will be described subsequently in greater detail is to provide a smart sign that allows users to interact with a digital real estate sign.

The digital touch screen real estate sign is preferably powered by solar energy, but may also be hardwired for electricity, at either 110 volts or 220 volts, so that the sign will still operate even when the sign's power requirements can't be met by solar energy. The sign will include a battery that collects and stores the necessary amount of solar energy to operate and may be double-sided.

The sign has a flexible base with a pivot point that allows the sign to bend near the base and withstand being struck or moved in heavy wind. The sign also has a camera, which is preferably also powered by solar energy. The camera allows users to remotely view the property for sale near the sign.

The digital touch screen smart sign also has a LED touch screen, allowing users to interact with the sign, and will be operable via Wi-Fi and Bluetooth and the device will work in conjunction with an optional mobile application. The sign also includes a programmable device that can collect data entered on the touch screen by the user. Specific software will be used in conjunction with a smart phone or tablet and also along with the mobile application.

The sign will include a screen and a stand. The height and length of the screen size will be anywhere from 0 to 1,000 feet. The width will be anywhere from 0 to 1,000 feet. The screen is preferably 2-3 feet in height and 2-3 feet in width. The stand is preferably 6-8 feet in height.

The shape of the sign will include a square, round, oval, triangle, hexagon, octagon, and rectangle. The sign can be made of materials including, but not limited to wood, metal, carbon fiber, and plastic.

The sign and stand will be able to light up and market the homes. It will also allow the realtor to change status on their listings, pending listings, escrows, and sold listings through their smart phones. The smart sign will allow potential buyers to get in contact with the listing agent directly from the sign.

The present invention holds significant improvements and serves as a digital touch screen smart real estate sign. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a digital touch screen smart real estate sign, constructed and operative according to the teachings of the present invention.

FIG. 1 shows a perspective view illustrating a digital touch screen real estate sign according to an embodiment of the present invention.

FIG. 2 is a perspective view illustrating a digital touch screen real estate sign according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a smart real estate sign and more particularly to a digital touch screen smart real estate sign as used to improve the connection between potential buyers and real estate agents.

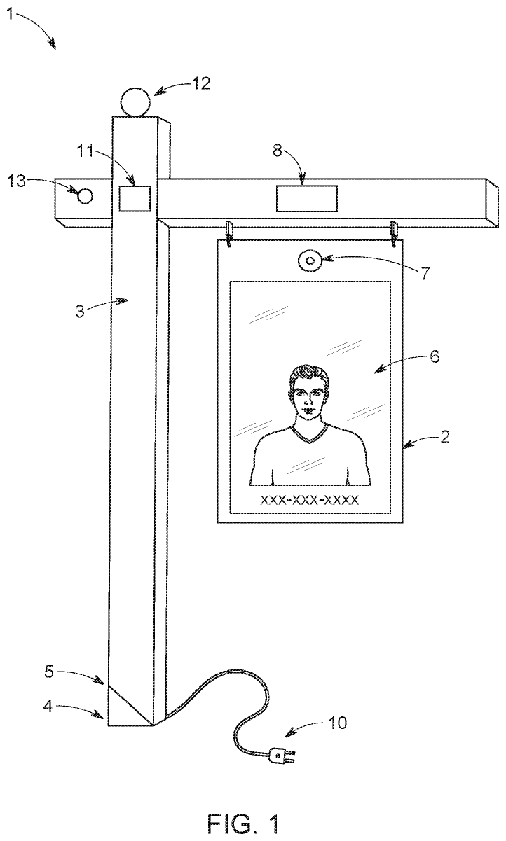

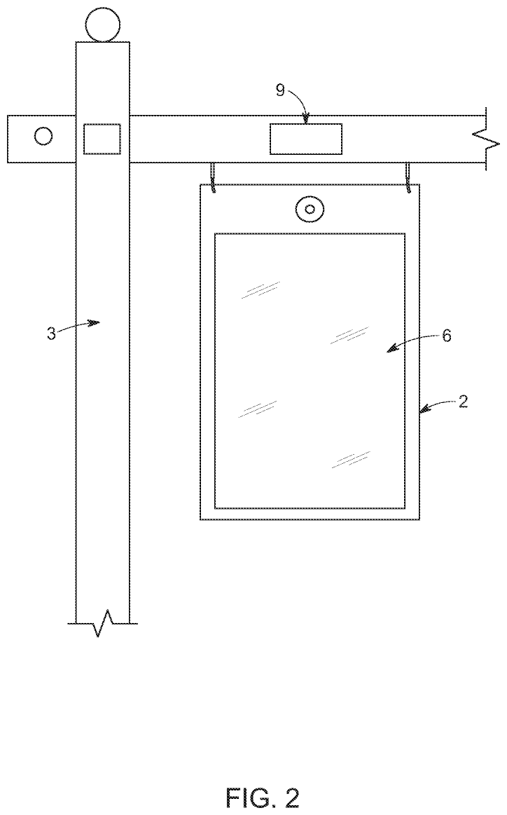

Referring to the drawings by numerals of reference there is shown in FIGS. 1 and 2, a digital touch screen smart real estate sign. The sign 1 includes a screen 2 and a stand 3. The height and length of the screen size may be manufactured anywhere from 0 to 1,000 feet, but is preferably 2-3 feet in height and 2-3 feet in width. The stand 3 must be taller and wider than the screen 2, and is preferably 6-8 feet in height, and 3-5 feet in width.

The stand 3 has a flexible base 4 with a pivot point 5 that allows the stand 3 to bend near the base 4 and withstand being struck or moved in heavy wind.

The screen 2 has a touch screen display area 6, allowing users to interact with the sign 1. The screen 2 may be backlit with light emitting diode bulbs, or similar, so that it's visible even at night. The sign 1 also has one or more cameras 7, on of which may be located on the screen 2. The camera(s) 7 may allow users to remotely view the property for sale near the sign 1, and may also allow the users to videoconference with the listed real estate agent. The sigh 1 may optionally include a projector 12.

The screen 2 and the cameras 7 may be operable via Wi-Fi and/or Bluetooth, allowing real estate agents to remotely update the display 6 on the screen 2, or answer calls from potential buyers. Users may also be able to remotely control a camera 7 to see different views of the property.

The sign 1 also includes a programmable device 8 that runs a program to control the display 6, camera(s) 7, and any additional software, including but not limited to a program to collect data entered on the touch screen by the user. The programmable device 8 is preferably located inside the screen 2 or stand 3. The programmable device 8 will also allow the realtor to change the display 6 to update the status on the listings, pending listings, escrows, and sold listings remotely via the realtor's laptop or smart phone. The programmable device is connected to a wireless internet receiver 13, in order for any software installed thereon to connect to wireless connections such as Wi-Fi or Bluetooth as needed.

The sign 1 has one or more solar panels 9, is preferably powered by solar energy, but may also be hardwired 10 for electricity, at either 110 volts or 220 volts, so that the sign 1 will still operate even when the sign's power requirements can't be met by solar energy. The sign 1 will include a battery 11 connected to the solar panel(s) 9 and/or the external hardwired power source 10. The battery 11 collects and stores the necessary amount of solar energy to operate.

The shape of the screen 2 can include a square, round, oval, triangle, hexagon, octagon, and/or rectangle. The sign 1 can be made of materials including, but not limited to wood, metal, carbon fiber, and plastic.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A digital touch screen real estate sign comprising:
(a) a screen with a display area,
wherein the screen is a digital touch screen;
(b) a stand with a flexible base and a pivot point,
wherein the stand supports the screen in an upright position;
(c) at least one solar cell;
(d) a battery,
wherein the at least one solar cell is operably connected to power the screen and charge the battery,
wherein the battery is operably connected to the screen as a back up power source for the solar cell;
(e) a hardwired power cord,
wherein the power cord is connectable to a 110 volt or 220 volt external electricity supply;
(f) a wireless internet receiver;
(g) a programmable device,
wherein the programmable device is operably connected to the wireless internet receiver and the screen to control the display of the screen so that a remote user can alter the display of the screen via a remote device over a wireless internet connection; and
(h) one or more cameras, wherein the one or more cameras are operably connected to the programmable device and to the display of the screen so that the camera displays images on the display of the screen, is operable by a user of the screen, or is operable by a remote user via the programmable device, or is operably by the user of the screen and by the remote user via the programmable device.

2. The digital touch screen real estate sign according to claim 1, wherein the stand comprises one or more materials selected from the list consisting of wood, metal, carbon fiber, and plastic.

3. The digital touch screen real estate sign according to claim 1, wherein the screen is manufactured in a shape selected from the list consisting of a square, a round, an oval, a triangle, a hexagon, an octagon, and a rectangle.

4. The digital touch screen real estate sign according to claim 1, wherein the stand has a greater height and a greater width than the screen.

5. The digital touch screen real estate sign according to claim 1, wherein the screen has height between 2 and 3 feet, and
wherein the screen has a width between 2 and 3 feet.

6. The digital touch screen real estate sign according to claim 1, wherein the stand has a height between 6 and 8 feet, and
wherein the stand has a width between 3 and 5 feet.

7. The digital touch screen real estate sign according to claim 1, wherein the programmable device is operably connected to the camera and the wireless internet connection so that the user of the screen can videoconference with the remote user.

8. The digital touch screen real estate sign according to claim 1, further comprising:
(i) a projector operably connected to the programmable device so that it projects images as directed by the programmable device.

9. The digital touch screen real estate sign according to claim 1, wherein one of the one or more cameras is located on a front surface of the screen.

10. A digital touch screen real estate sign comprising:
(a) a screen with a display area,
wherein the screen is a digital touch screen,
wherein the screen is manufactured in a shape selected from the list consisting of a square, a round, an oval, a triangle, a hexagon, an octagon, and a rectangle,
wherein the screen has height between 2 and 3 feet, and
wherein the screen has a width between 2 and 3 feet;
(b) a stand with a flexible base and a pivot point,
wherein the stand supports the screen in an upright position,
wherein the stand comprises one or more materials selected from the list consisting of wood, metal, carbon fiber, and plastic
wherein the stand has a height between 6 and 8 feet, and
wherein the stand has a width between 3 and 5 feet;
(c) at least one solar cell;
(d) a battery,
wherein the at least one solar cell is operably connected to power the screen and charge the battery,
wherein the battery is operably connected to the screen as a back up power source for the solar cell;
(e) a hardwired power cord,
wherein the power cord is connectable to a 110 volt or 220 volt external electricity supply;
(f) a wireless internet receiver;
(g) a programmable device,
wherein the programmable device is operably connected to the wireless internet receiver and the screen to control the display of the screen so that a remote user can alter the display of the screen via a remote device over a wireless internet connection;
(h) at least one camera, wherein the camera is operably connected to the programmable device and to the display of the screen so that the camera displays images on the display of the screen, is operable by a user of the screen, or is operable by a remote user via the programmable device, or is operably by the user of the screen and by the remote user via the programmable device; and
(i) a projector operably connected to the programmable device so that it projects images as directed by the programmable device.

11. The digital touch screen real estate sign according to claim 10, wherein the programmable device is operably connected to the camera and the wireless internet connection so that the user of the screen can videoconference with the remote user.

12. The digital touch screen real estate sign according to claim 10, wherein one of the one or more cameras is located on a front surface of the screen.
